(19) United States
(12) Patent Application Publication
(10) Pub. No.: US 2010/0071736 A1
(43) Pub. Date: Mar. 25, 2010

(54) CLEANING APPARATUS FOR SIMULTANEOUS CLEANING OF MULTIPLE ENDOSCOPES AND MAINTENANCE MANAGEMENT APPARATUS THEREOF

(75) Inventors: Chieko WATANABE, Tokyo (JP); Tatsuya SHIOBARA, Tokyo (JP); Hiroyuki ARAKI, Kanagawa (JP); Hidenori TSURUMA, Tokyo (JP); Atsushi SUGIYAMA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS MEDICAL SYSTEMS CORP., Tokyo (JP)

(21) Appl. No.: 12/564,273

(22) Filed: Sep. 22, 2009

(30) Foreign Application Priority Data
Sep. 24, 2008 (JP) 2008-244305

(51) Int. Cl. B08B 3/00

(52) U.S. Cl. 134/56 R

(57) ABSTRACT

In a cleaning apparatus that can clean multiple endoscopes simultaneously, a combination authorization information memory unit stores combination authorization information that specifies whether or not simultaneous cleaning in the cleaning apparatus is allowed for every combination of various types of endoscopes. A determination unit determines, referring to the combination authorization information stored in the combination authorization information memory unit, whether or not the combination of endoscopes set in the cleaning apparatus to be simultaneously cleaned falls into one of the allowed combinations.

### BACKGROUND OF THE INVENTION

1. Field of the Invention

The present invention relates to a cleaning apparatus for the simultaneous cleaning of multiple endoscopes and a maintenance management apparatus thereof.

2. Description of the Related Art

Endoscopes used for endoscopic examinations need to be cleaned every time the examinations are finished. Therefore, a cleaning apparatus, which is used for cleaning used endoscopes, is installed in a medical facility. A cleaning apparatus that can be used to perform simultaneous cleaning of multiple endoscopes, for example, two endoscopes, is in practical use.

There are various types of endoscopes, for example, those used for upper gastrointestinal tracts and those used for lower gastrointestinal tracts. The maker for the above-mentioned cleaning apparatus for the simultaneous cleaning of multiple endoscopes has released a combination of endoscopes that can be cleaned simultaneously.

[Patent document 1] JP 2007-316860

[Patent document 2] JP 2006-149873

In the cleaning apparatus, a common channel is used for a fluid (e.g. clean solution, water, alcohol, sterilization solution, or air) needed to be delivered into each of the channels of the multiple endoscopes to be cleaned simultaneously. The channel structure and channel resistance of an endoscope vary depending on its type. Therefore, depending on the combination of endoscopes set to the cleaning apparatus, there may be situations where the high channel resistance of an endoscope results in excessive amount of fluid flowing into other endoscopes and where the low channel resistance of an endoscope results in deficient amount of fluid flowing into other endoscopes. An endoscope will more likely to have a failure in the former case, and an endoscope may not experience enough cleaning effect in the latter case. In the combination of endoscopes all having high channel resistances, the cleaning apparatus itself is more likely to result in failure.

In the past, a nurse or a worker in charge of a cleaning task (hereinafter, generically referred to as a “person in charge of a cleaning task”) performed the task while paying attention so as not to set an inappropriate combination of endoscopes in the cleaning apparatus in reference to the table containing the description of the combinations of endoscopes approved by a maker. However, on the job at a medical facility where people work under extreme pressure, a mistake in checking the combination of endoscopes sometimes resulted in cleaning an inappropriate combination of endoscopes in the cleaning apparatus.

### SUMMARY OF THE INVENTION

One embodiment of the present invention relates to a cleaning apparatus that can clean a plurality of endoscopes simultaneously comprises: a combination authorization information memory unit operative to store combination authorization information that specifies whether or no simultaneous cleaning in the cleaning apparatus is allowed for every combination of various types of endoscopes; and a determination unit operative, referring to the combination authorization information stored in the combination authorization information memory unit, to determine whether or not the combination of endoscopes set to be cleaned simultaneously in the cleaning apparatus falls into one of the allowed combinations.

Another embodiment of the present invention relates to a maintenance management apparatus. The apparatus is a maintenance management apparatus connected via a network to a cleaning apparatus that can clean a plurality of endoscopes simultaneously and comprises: a combination authorization information memory unit operative to store combination authorization information that specifies whether or not simultaneous cleaning in the cleaning apparatus is allowed for every combination of various types of endoscopes; an acquisition unit operative to acquire from the cleaning apparatus via the network the identification information of a plurality of endoscopes set in the cleaning apparatus to be cleaned simultaneously in the cleaning apparatus; and a determination unit operative, referring to the combination authorization information stored in the combination authorization information memory unit, to determine whether or not the combination of a plurality of endoscopes identified by the identification information of a plurality of endoscopes acquired by the acquisition unit falls into one of the allowed combinations.

Optional combinations of the aforementioned constituent elements, or implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a perspective view of a cleaning apparatus according to the embodiment 1 of the present invention;

FIG. 2 is a top view of the cleaning apparatus showing the state where two endoscopes are placed in a cleaning/sterilization tank in FIG. 1 when the top cover is open;

FIG. 3 is a schematic diagram showing the state of the connection of two endoscopes where each channel connection port and each port for dual air/water pump and forceps inlet in FIG. 2 are connected to a cleaning tube;

FIG. 4 is a view showing the internal configuration of the cleaning apparatus in FIG. 1;

FIG. 5 is a functional block diagram of the cleaning apparatus according to the embodiment 1 of the present invention;

FIG. 6 is a view showing the configuration example of combination authorization information established in a combination authorization information memory unit according to the embodiment 1 of the present invention;

FIG. 7 is a flowchart showing the process of determining the combination of endoscopes in the cleaning apparatus according to the embodiment 1 of the present invention;

FIG. 8 is a diagram showing the whole configuration of a maintenance management system according to the embodiment 2 of the present invention;

FIG. 9 is a functional block diagram of the cleaning apparatus according to the embodiment 2 of the present invention;

FIG. 10 is a functional block diagram of the maintenance management apparatus according to the embodiment 2 of the present invention;

FIG. 11 is a diagram showing an error and prior warning list screen of a remote diagnosis support system;

FIG. 12 is a diagram showing a facility information detail screen of a remote diagnosis support system;

FIG. 13 is a diagram showing a combination-of-scopes-to-be-cleaned error screen of a remote diagnosis support system; and

FIG. 14 is a diagram showing a water-supply time transition screen of a remote diagnosis support system.

### DETAILED DESCRIPTION OF THE INVENTION

The invention will now be described by reference to the preferred embodiments. This does not intend to limit the scope of the present invention but to exemplify the invention.

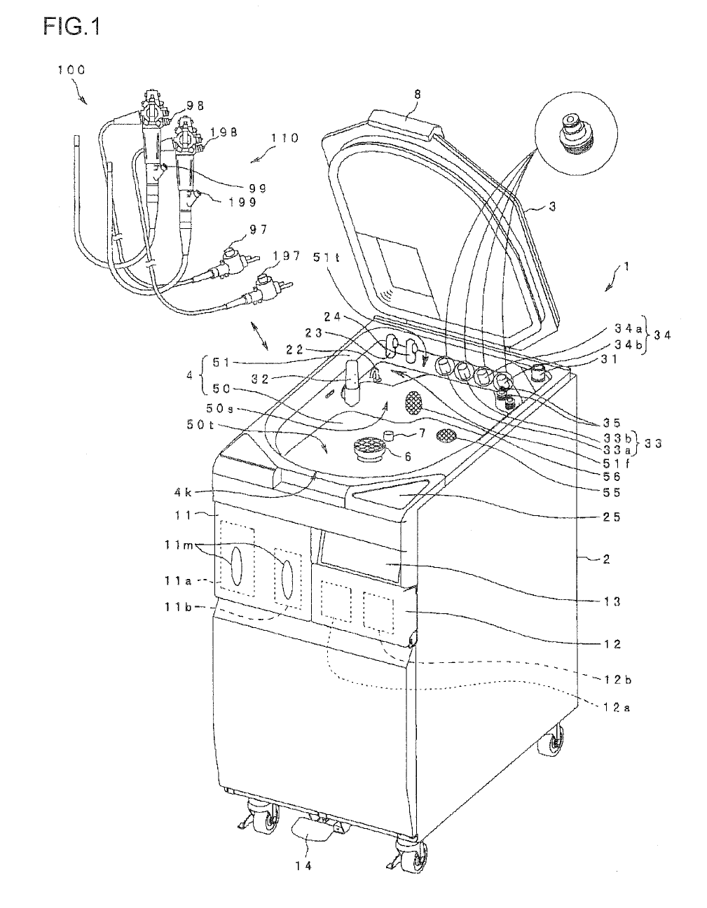

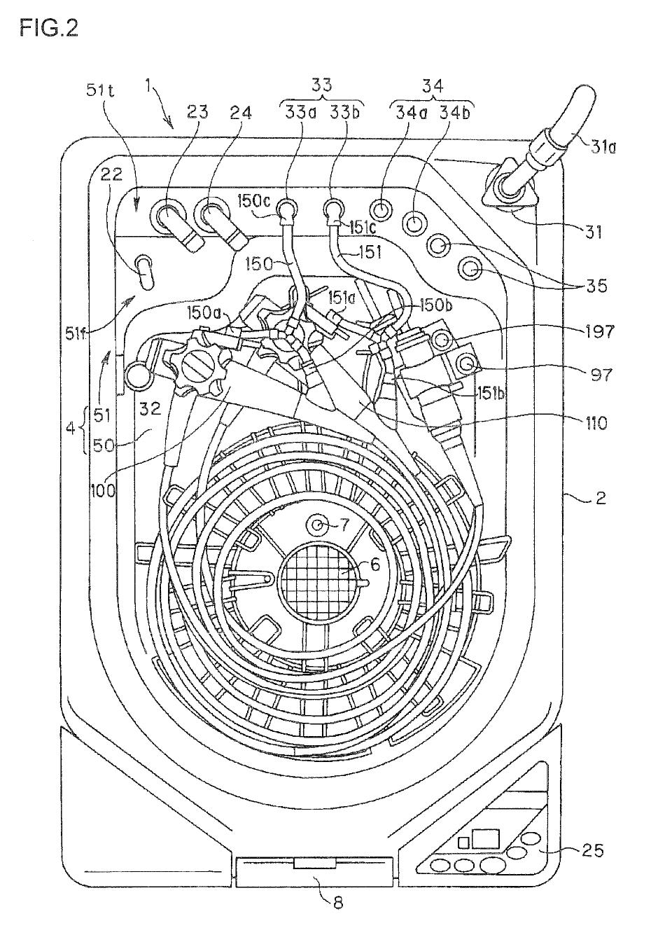

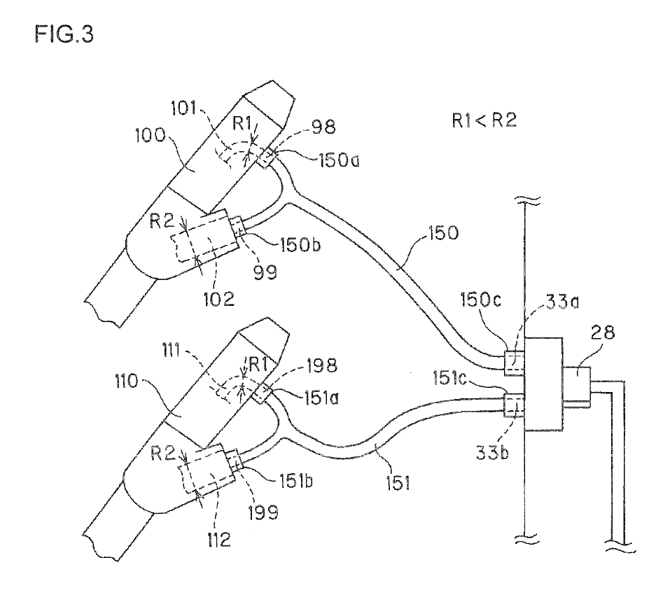

FIG. 1 is a perspective view of a cleaning apparatus 1 according to the embodiment 1 of the present invention. FIG. 2 is a top view of the cleaning apparatus 1 showing the state where two endoscopes are placed in a cleaning/sterilization tank 4 in FIG. 1 when the top cover is open. FIG. 3 is a schematic diagram showing the connection state of two endoscopes where each channel connection port and each port for dual air/water pump and forceps inlet in FIG. 2 are connected to a cleaning tube.

As shown in FIG. 1, the cleaning apparatus 1 is an apparatus for cleaning and sterilizing two used endoscopes (hereinafter, the two endoscopes are referred to as a first endoscope 100 and a second endoscope 110, respectively) both at the same time. The principal part of the apparatus is constituted by a cleaning apparatus body (hereinafter, simply referred to as an apparatus body) 2 and a top cover 3 connected at the top thereof, for example, via a hinge (not shown) so that it opens and closes with complete control.

The cleaning apparatus 1 can also clean and sterilize only one endoscope, i.e., either one of the first endoscope 100 and the second endoscope 110. However, since the theme of the embodiment is to clean and sterilize two at the same time, a detailed description will be made regarding the cleaning and sterilization of two at the same time.

A configuration is employed where the apparatus body 2 and the top cover 3, after they are closed, are locked by, for example, a latch 8 that is set up at the position where the apparatus body 2 and the top cover 3 face to each other.

A detergent/alcohol tray 11 is set up, for example, at the upper part of the left half of the front surface (hereinafter, referred to as a “front surface”), which is close to an operator, of the apparatus body 2 in FIG. 1 so as to be pulled out forwardly with complete control from the apparatus body 2.

Tanks are stored in the detergent/alcohol tray 11: a tank 11a in which a detergent, which is a liquid, was poured that is used for cleaning the first endoscope 100 and the second endoscope 110; and a tank 11b in which an alcohol, which is a liquid, was poured that is used for drying the endoscope 100 after the cleaning and sterilization. Since the detergent/alcohol tray 11 can be pulled out with complete control, a predetermined liquid can be refilled in each of the tanks 11a and 11b.

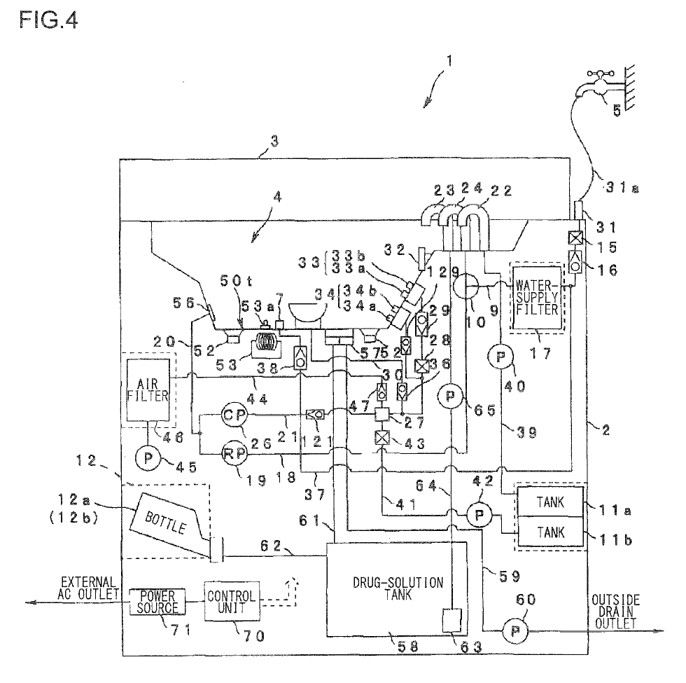

The detergent poured in the tank 11a is a concentrated detergent that will be diluted to a predetermined concentration with tap water filtered by a water-supply filter 17 (see FIG. 4) that will be described hereinafter. In the embodiment, a liquid mixture of the detergent and the tap water is referred to as a clean solution in the following descriptions.

The detergent/alcohol tray 11 is provided with windows 11m, and the operator can check the remaining amount of the detergent and alcohol that were poured in the tanks 11a and 11b, respectively, through the windows 11m.

A cassette tray 12 is set up on the front surface, for example, at the upper part of the right half of the apparatus body 2 so as to be pulled out forwardly from the apparatus body 2 with complete control. Bottles are stored in the cassette tray 12: a bottle 12a in which a liquid main substance was poured, such as acetyl hydroperoxide, which is used as a sterilization solution that is used to sterilize the endoscope 100; and a bottle 12b in which a buffering agent for the main substance was poured. Since the cassette tray 12 can be pulled out with complete control, predetermined liquids can be refilled in the bottles 12a and 12b.

Furthermore, a sub operation panel 13 is provided with an instruction button, etc., for displaying the time required for the cleaning and sterilization or for warming up the sterilization solution and is set up at the upper part of the cassette tray 12 on the front surface of the apparatus body 2.

A pedal switch 14 is set up, in the figure, at the lower part of the front surface of the apparatus body 2, which is for opening the top cover 3, which is closed above the apparatus body 2, upwardly from the apparatus body 2 by the step-on manipulation by the operator.

A main manipulation panel 25 is provided on the top surface of the apparatus body 2, for example, at the far right in the figure of the front side close to the operator, including setting switches for the apparatus body 2 such as a switch for starting cleaning/sterilization and a switch for selecting cleaning/sterilization modes.

A water-supply-hose connection port 31 is provided for the connection with a water-supply hose 31a connected to a water faucet (not shown) (see FIG. 4 for both), which is set up on the upper surface of the apparatus body 2 on the back side opposite the front surface close to the operator and which is for supplying tap water to the apparatus body 2. A mesh filter for filtering tap water may be set up at the water-supply-hose connection port 31.

Furthermore, a cleaning/sterilization tank 4, where the first endoscope 100 and the second endoscope 110 can be freely placed as shown in FIG. 2, is provided approximately at the center of the upper surface of the apparatus body 2, where the endoscope placement port that opens on the upper side opens and closes by using the top cover 3. The cleaning/sterilization tank 4 is constituted with a tank body 50 and with a terrace unit 51 that peripherally and continuously furnishes the outside periphery of the endoscope placement port of the tank body 50.

In the cleaning and sterilization of the used first endoscope 100 and second endoscope 110, these first endoscope 100 and second endoscope 110 are freely placed in the tank body 50. Also, the tank body 50 is provided with a drain outlet 55 for draining from the tank body 50 the clean solution, water, sterilization solution, etc., which are the fluids supplied to the tank body 50, at the bottom surface 50t, which is the surface inside the tank body 50.

At any position on a circular side surface 50s, which is a surface of the tank body 50 inside the tank, a circulation port 56 is provided, which provides clean solution, water, sterilization solution, etc., provided to the tank body 50 via a method described hereinafter from the tank body 50 to each channel (described hereinafter) set up in the first endoscope 100 and in the second endoscope 110, and which provides the fluid back to the tank body 50 from a water supply/circulation nozzle 24 that will be described hereinafter. A filter that filters clean solution, water, sterilization solution, etc., may be set up at the circulation port 56.

The circulation port 56 may be provided at the bottom surface 50t of the tank body 50. If the circulation port 56 is provided at the bottom surface 50t of the tank body 50, the circulation port 56 can be submersed under water sooner; thus, the time required for supplying clean solution, water, sterilization solution, etc., to each channel of the endoscope 100 and again to the tank body 50 can be shortened. Furthermore, the circulation port 56 provided at the bottom surface has the advantage of easier approach by an operator in changing the filter, etc., provided at the circulation port 56 by a user.

At the approximate center of the bottom surface 50t of the tank body 50 of the cleaning/sterilization tank 4, a water-supply-pipe sterilization port 7 is provided that provides a sterilization solution for sterilizing the water-supply pipe (not shown) inside the cleaning apparatus 1 and that sterilizes the water-supply pipe.

Furthermore, at the approximate center of the bottom surface 50t of the tank body 50, a clean case 6 is provided for placing both a button and the like such as a scope switch and forceps plug, etc., of each of the first endoscope 100 and the second endoscope 110 and for cleaning and sterilizing the buttons and the like, forceps plug, etc., together with the first endoscope 100 and the second endoscope 110.

At an arbitrary position of a side surface 50s of the tank body 50, a water-level sensor 32 with a cover is provided for detecting the surface level of a clean solution, water, sterilization solution, etc., that are provided to the tank body 50.

The terrace unit 51 of the cleaning/sterilization tank 4 is constituted with an upwardly inclined surface, and more specifically, with a peripheral terrace surface 51t that is inclined at a specified angle from, for example, the bottom surface 50t of the tank body 50.

On the surface other than the terrace surface 51t of the terrace unit 51, i.e., a surface 51f parallel to the bottom surface 50t of the tank body 50, a detergent nozzle 22 is provided for providing a clean solution to the tank body 50 from the detergent tank 11a via a detergent-supply pump 40 that will hereinafter be described in detail (see FIG. 4). The detergent nozzle 22 may be provided on the terrace surface 51t.

On the terrace surface 51t of the terrace unit 51, a sterilization-solution nozzle 23 is provided for providing a sterilization solution from a drug-solution tank 58 (not shown) to the tank body 50.

Furthermore, on the terrace surface 51t, a water supply/circulation nozzle 24 is provided for providing the tank body 50 with water to be used for cleaning or rinsing or it is provided for providing the tank body 50 again with the clean solution, water, sterilization solution, etc., that are suctioned via the circulation port 56. The sterilization-solution nozzle 23 and the water supply/circulation nozzle 24 may be provided on the parallel surface 51f.

On the terrace surface 51t of the terrace unit 51 and on the opposite side of an operator's operation position 4k, a port 33 for dual air/water pump and forceps inlet comprising two ports 33a and 33b for providing a clean solution, water, alcohol, sterilization solution, or fluid such as air (hereinafter, generically referred to as a fluid) to each of the channels, which will be described hereinafter, provided inside of the first endoscope 100 and the second endoscope 110, a port 34 for auxiliary water/forceps-elevator comprising two ports 34a and 34b, and two ports 35 for water-leakage detection are provided. The number of each of the ports 33-35 is not limited to the number stated above.

A fluid is discharged concurrently or alternately from two ports 33a and 33b by a channel solenoid valve 28 (see FIGS. 3 and 4) that will be described hereinafter.

As shown in FIGS. 2 and 3, when the first endoscope 100 is used and then placed in the cleaning/sterilization tank 4, an inflow connection port 150c of a first branching tube 150, which is a first branching channel of a bifurcated outflow channel, for example, a Y-shaped channel, is connected to the port 33a, which is the first port, for dual air/water pump and forceps inlet.

A first outflow connection port 150a of the first branching tube 150 is connected to a channel connection port 98 on the outer surface of an air/water channel 101 (hereinafter, referred to as an AW channel), which is a first channel provided in the first endoscope 100.

A second outflow connection port 150b of the first branching tube 150 is connected to a channel connection port 99 on the outer surface of an instrument channel 102 (hereinafter, referred to as a S channel) that also works as a suction channel, which is a second channel having a larger diameter than the AW channel 101 (R1<R2) provided in the first endoscope 100.

As shown in FIGS. 2 and 3, when the second endoscope 110 is used and then placed in the cleaning/sterilization tank 4, an inflow connection port 151c of a second branching tube 151, which is a second branching channel of a bifurcated outflow channel, for example, a Y-shaped channel, is connected to the port 33b, which is the second port, for dual air/water pump and forceps inlet.

A first outflow connection port 151a of the second branching tube 151 is connected to a channel connection port 198 on the outer surface of an AW channel 111, which is a first channel provided in the second endoscope 110.

A second outflow connection port 151h of the second branching tube 151 is connected to a channel connection port 199 on the outer surface of a S channel 112 that also works as a suction channel, which is a second channel having a larger diameter than the AW channel 111 (R1<R2) provided in the second endoscope 110.

In the case where the first endoscope 100 and the second endoscope 110 each has an auxiliary water/forceps-elevator channel, one end of a cleaning tube (not shown), whose other end is connected to the channel connection port of the auxiliary water/forceps-elevator channel of the first endoscope 100, is connected to a port 34a for auxiliary water/forceps-elevator.

One end of a cleaning tube (not shown), whose other end is connected to the channel connection port of the auxiliary water/forceps-elevator channel of the second endoscope 110, is also connected to a port 34b for auxiliary water/forceps-elevator.

Furthermore, as shown in FIG. 2, one end of a cleaning tube (not shown), whose other end is connected to a connection port 97 for water-leakage detection of the first endoscope 100, and one end of a cleaning tube (not shown), whose other end is connected to a connection port 197 for water-leakage detection of the second endoscope 110, each is connected to each of two ports 35 for water-leakage detection.

A detailed description will be made regarding the internal configuration of the cleaning apparatus 1 in FIG. 1 by using FIG. 4. FIG. 4 is a view showing the internal configuration of the cleaning apparatus 1 in FIG. 1. Note that the above-stated port 35 for water-leakage detection and the circuits, etc., communicated with the port 35 are omitted in the description of the internal configuration shown in the following.

As shown in FIG. 4, tap water is provided to the cleaning apparatus 1 by a water-supply hose 31a whose one end is connected to the water-supply-hose connection port 31 and whose other end is connected to an outside water faucet 5.

The water-supply-hose connection port 31 is communicated with one end of a water-supply channel 9. The other end of the water-supply channel 9 is connected to a three-way solenoid valve 10, and a water-supply solenoid valve 15, a check valve 16, and a water-supply filter 17 are interposed in the said order from the water-supply-hose connection port 31 in the middle of the channel.

The water-supply filter 17 is provided with a cartridge-type filter so as to be replaced on regular basis. As stated previously, by passing through the water-supply filter 17, foreign particles are removed from tap water.

The three-way solenoid valve 10 is connected to one end of a fluid channel 18 and switches the communication of the water-supply channel 9 from/to the communication with the water supply/circulation nozzle 24 to/from the communication with the fluid channel 18 by using an internal valve thereof. In other words, the water supply/circulation nozzle 24 is communicated with either one of the water-supply channel 9 and the fluid channel 18 by the switching operation of the three-way solenoid valve 10. Also, a fluid pump 19 is interposed at the other end of the fluid channel 18.

The circulation port 56 set up on the cleaning/sterilization tank 4 is connected to one end of a circulation channel 20. The other end of the circulation channel 20 branches into two channels so as to be communicated with the other end of the fluid channel 18 and with one end of a channel 21.

The other end of the channel 21 is communicated with each of the ports 33a and 33b for dual air/water pump and forceps inlet and with each of the ports 34a and 34b for auxiliary water/forceps-elevator.

A channel pump 26, a check valve 121, a channel block 27, a CH (channel) solenoid valve 28, and check valves 29 and 129 are interposed in the midway of the channel 21 in the said order from the one end of the channel 21.

The CH solenoid valve 28 delivers fluids delivered by the channel pump 26, such as the clean solution and sterilization solution, to both the port 33 for dual air/water pump and forceps inlet and the port 34 for auxiliary water/forceps-elevator at the same time or only to the port 34 for auxiliary water/forceps-elevator. The CH solenoid valve 28 delivers fluids delivered by the channel pump 26, such as the clean solution and sterilization solution, to both the port 33 for dual air/water pump and forceps inlet and the port 34 for auxiliary water/forceps-elevator at the same time or only to the port 34 for auxiliary water/forceps-elevator.

In other words, the fluid or air is delivered into the port 33 for dual air/water pump and forceps inlet and to the port 34 for auxiliary water/forceps-elevator when the CH solenoid valve 28 is open, and the fluid or air is delivered into the port 34 for auxiliary water/forceps-elevator only when the CH solenoid valve 28 is open.

The CH solenoid valve 28 is arranged so as to be opened and closed by the opening and closing control of a control unit 70, which will be described hereinafter.

One end of a case channel 30, whose other end is connected to the clean case 6, is connected to the channel 21 between the channel block 27 and the CH solenoid valve 28. A relief valve 36 is interposed in this case channel 30.

Also, one end of a sterilization channel 37 is connected to the water-supply-pipe sterilization port 7 placed on the cleaning/sterilization tank 4, and the other end of the sterilization channel 37 is connected to the water-supply channel 9 between the water-supply filter 17 and the check valve 16. A check valve 38 is interposed in the sterilization channel 37 on the water-supply-pipe sterilization port 7.

The detergent nozzle 22 is connected to one end of a detergent channel 39, and the other end of the detergent channel 39 is connected to the detergent tank 11a. The detergent-supply pump 40 is interposed in the midway of this detergent channel 39.

An alcohol tank 11b is connected to one end of an alcohol channel 41, and the alcohol channel 41 is connected to the channel block 27 so as to be communicated with the channel 21 at a predetermined position. In the alcohol channel 41, an alcohol supply pump 42 is interposed on the side of the alcohol tank 11b and the solenoid valve 43 is interposed on the side of the channel block 27.

Also, one end of an air channel 44 for providing the air from the air pump 45 constituted with, for example, a compressor, which is an air-feeding apparatus is connected to the channel block 27 so as to be communicated with the channel 21 at a predetermined position.

The other end of the air channel 44 is connected to the air pump 45, and a check valve 47 is interposed therein on the side of the channel block 27 and an air filter 46 that is replaced on regular basis is interposed therein on the side of the air pump 45.

A switching valve 57 is set up on a drain outlet 55 of the cleaning/sterilization tank 4 so as to, for example, drain the clean solution, etc., outside and collect the sterilization solution into the drug-solution tank 58 by the switching operation of the valve. The switching valve 57 is connected to one end of a drainage channel 59 whose other end is connected and communicated with a water discharge hose (not shown) connected to an outside drain outlet, and a drain pump 60 is interposed in the drainage channel 59. The switching valve 57 is connected to one end of a drug-solution collection channel 61, and the other end of the drug-solution collection channel 61 is connected to the drug-solution tank 58.

The drug-solution tank 58 is also connected to one end of a drug-solution collection channel 62 so that the mixed sterilization, from both a bottle 12a in which the main substance such as sterilization solution is poured and a bottle 12b in which a buffering agent for the main substance is poured, can be provided. The other end of the drug-solution collection channel 62 is connected to the cassette tray 12 at a predetermined position.

In the drug-solution tank 58, one end portion of a drug-solution collection channel 64 whose one end is provided with a suction filter 63 is placed at a predetermined position. The other end of the drug-solution collection channel 64 is connected to the sterilization-solution nozzle 23, and a fluid pump 65 is interposed midway.

On the back of the bottom surface 50t of the tank body 50, a plurality of, for example, two ultrasonic transducers 52 and a heater 53 are set up. The number of tale ultrasonic transducer 52 is not limited to two. For the temperature adjustment of the heater 53, a temperature detection sensor 53a that provides the control unit 70 with a detection result is provided at the approximate center of the bottom surface 50t of the cleaning/sterilization tank 4.

The heater 53 is used to heat the sterilization solution that is stored in the cleaning/sterilization tank 4 and circulates in the apparatus so that the sterilization solution reaches a predetermined temperature. The sterilization solution has an optimal temperature at which an optimal sterilization effect can be expected, and by heating the sterilization solution to the predetermined temperature by the heater 53, which is the optimal temperature, the first endoscope 100 and the second endoscope 110 are effectively sterilized.

The temperature detection sensor 53a detects the liquid temperature of the sterilization temperature that is stored in the cleaning/sterilization tank 4 and circulates in the apparatus and then provides the control unit 70 with the detection result. Based on the detection result from the temperature detection sensor 53a, the control unit 70 controls the heater 53 to be activated or to be stopped in order for the sterilization solution to keep the predetermined temperature.

Furthermore, in the cleaning apparatus 1, both a power source 71 to which electricity is provided from an external AC outlet and the control unit 70 connected electrically to the power source 71 are provided. Upon the provision of various kinds of signals from both the main operation panel 25 and the sub operation panel 13 shown in FIG. 1, the control unit 70 controls the drive of respective pumps and solenoid valves stated above.

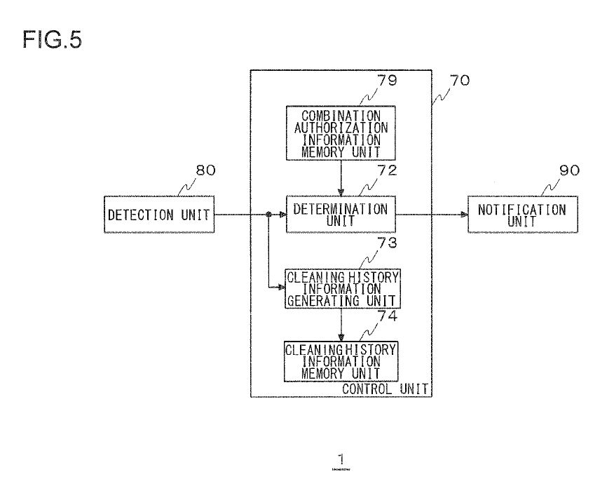

FIG. 5 is a functional block diagram of the cleaning apparatus 1 according to the embodiment 1 of the present invention. In the figure, only functions are described that associated with a function to determine the combination of endoscopes to be set simultaneously in the cleaning apparatus 1. The cleaning apparatus 1 according to the embodiment is provided with the control unit 70, a detection unit 80, and a notification unit 90. The control unit 70 includes a combination authorization information memory unit 79, a determination unit 72, a cleaning history information generating unit 73, and a cleaning history information memory unit 74.

The configuration of the control unit 70 is implemented in hardware by any CPU of a computer, a memory or other LSI's, and in software by a program or the like loaded into the memory. Functional blocks are implemented by the cooperation of hardware and software. Thus, a person skilled in the art should appreciate that there are many ways of accomplishing these functional blocks in various forms in accordance with the components of hardware only, software only, or the combination of both.

The detection unit 80 detects the identification information of an endoscope set in the cleaning apparatus 1. The identification information of an endoscope detected by the detection unit 80 is output to both the combination authorization information memory unit 79 and the cleaning history information generating unit 73. The detection unit 80 may be installed as a sensor panel on the main operation panel 25. A scope ID tag is added to an endoscope. More specifically, it is added to a universal code of an endoscope. The unique information of an endoscope such as the model name or serial number is recorded in the scope ID tag and can be used as the identification information stated above.

The sensor panel and the scope ID tag may be able to communicate with each other by an RFID (Radio Frequency IDentification) method. In this case, when a person in charge of a cleaning task sets a used endoscope in the cleaning/sterilization tank 4 of the cleaning apparatus 1, holding the scope ID tag of the endoscope over the sensor panel allows the identification information of the endoscope to be loaded into the cleaning apparatus 1. The cleaning apparatus 1 may be set so that the cleaning of an endoscope will not start until the identification information of the endoscope to be cleaned is loaded. In this case, the receipt of the identification information of two endoscopes transmitted from the detection unit 80 before the start of the cleaning allows the determination unit 72 to determine that those two endoscopes should be cleaned simultaneously.

A supervisor at a medical facility may let a person in charge of a cleaning task wear a worker ID tag. The unique information of a person in charge of a cleaning task such as his/her name or the division he/she belongs to is recorded in the worker ID tag as the identification information of the person in charge of a cleaning task. When a person in charge of a cleaning task sets a used endoscope in the cleaning/sterilization tank 4 of the cleaning apparatus 1, holding his/her worker ID tag over the sensor panel allows the identification information of the person in charge of a cleaning task to be loaded into the cleaning apparatus 1. More specifically, the identification information of a person in charge of a cleaning task detected by the detection unit 80 is output to the cleaning history information generating unit 73. The cleaning apparatus 1 may be set so that the cleaning of an endoscope will not start until the identification information of the person in charge of a cleaning task is loaded.

For every combination of the various endoscopes, the combination authorization information memory unit 79 stores combination authorization information that specifies whether or not the simultaneous cleaning in the cleaning apparatus 1 is authorized by the maker of the cleaning apparatus. The combination authorization information may be operation confirmation information that specifies whether or not the operation of the simultaneous cleaning in the cleaning apparatus 1 is confirmed. There are various types of endoscopes depending on their use, for example, endoscopes used for upper gastrointestinal tracts and endoscopes used for lower gastrointestinal tracts. There are various types of endoscopes that are of different insertion types, such as nasal insertion types or oral insertion types. In view of, for example, the structure of channels of various endoscopes, a maker of a cleaning apparatus determines a combination of endoscopes that does not cause a failure but allows an effective cleaning, and he/she registers the combination in advantage in the combination authorization information memory unit 79. These combinations may be determined by examinations and simulations.

The width of a channel, etc. may vary depending on an endoscope maker even if its use, its insertion type, etc., are the same. In that case, the endoscope is considered to be a different type even if its use, its insertion type, etc., are the same. The combination of the endoscopes, which is registered in the combination authorization information memory unit 79 and for which the simultaneous cleaning is permitted, needs to be updated when a new endoscope model comes out. When the cleaning apparatus 1 is connected to the network, the update data can be downloaded from the server of the maker of the cleaning apparatus and then updated. If the cleaning apparatus 1 is stand-alone, the updates can be done manually by a service engineer of the maintenance management company of the cleaning apparatus 1.

Prior to the simultaneous cleaning of multiple endoscopes in the cleaning apparatus 1, the determination unit 72 acquires the respective identification information of multiple endoscopes detected by the detection unit 80, then identifies the type of each endoscope from the identification information, and identifies the combination of endoscopes that are set in the cleaning apparatus 1. Referring to the combination authorization information stored in the combination authorization information memory unit 79, the determination unit 72 determines whether or not the combination of the set endoscopes falls into one of the combinations for which simultaneous cleaning is allowed. As a result of the determination, if the combination is found not to be allowed, the determination unit 72 notifies the notification unit 90 of the according information. The according information may be output to the cleaning history information generating unit 73. The cleaning apparatus 1 may be set so that the cleaning of multiple endoscopes, for which simultaneous cleaning is not allowed, will not start.

When an endoscope is cleaned in the cleaning apparatus 1, the cleaning history information generating unit 73 generates a cleaning history thereof and then registers the cleaning history in the cleaning history information memory unit 74. The cleaning history information includes both the identification information of the endoscope obtained from the detection unit 80 and at least either the cleaning starting time or the cleaning ending time. In addition, the identification information of the person in charge of a cleaning task, the cleaning time, the presence or absence of an error, etc., may be included. If the cleaning apparatus is provided with a printer therein, the cleaning history information stored in the cleaning history information generating unit 73 may be output by being printed out by the printer.

When the determination unit 72 determines that the combination of endoscopes not allowed for simultaneous cleaning is actually placed in the cleaning apparatus 1, the notification unit 90 notifies a worker of the according information. For example, the notification unit 90 audibly outputs a voice message indicating the according information, an alert sound, etc., to the outside. Also, if a warning light is installed on, for example, the main operation panel 25 to indicate that a combination of endoscopes not allowed for simultaneous cleaning is actually placed in, the warning light goes on or flashes.

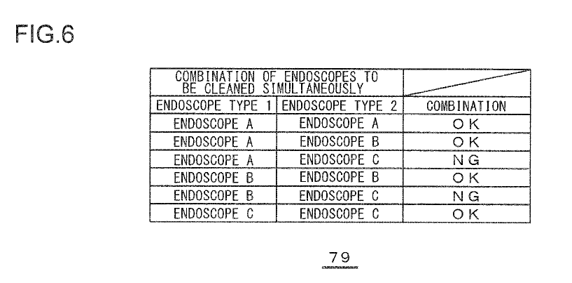

FIG. 6 is a view showing the configuration example of combination authorization information constructed in a combination authorization information memory unit 79 according to the embodiment 1 of the present invention. In order to simplify the explanation, it is assumed that there are three kinds of endoscopes: an endoscope A; an endoscope B; and an endoscope C. FIG. 6 shows a table that describes whether or not simultaneous cleaning is allowed for each of all six combinations of endoscopes among the three different kinds. The combination authorization information can be described in various configurations. For example, the following two tables may describe the combination authorization information after defining multiple groups obtained by grouping those with the same use or those whose channel structures are similar. Among these two tables, the first table is for the description indicating which group the various endoscopes belong to, and the second table is for the description indicating whether or not simultaneous cleaning is allowed for each of all the combinations of those groups.

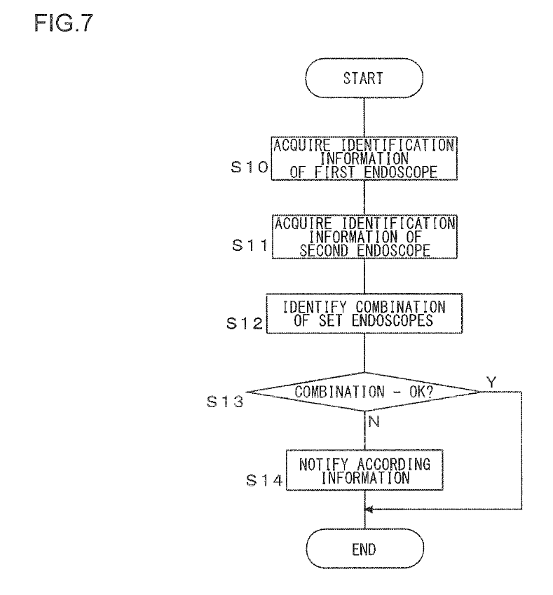

FIG. 7 is a flowchart showing the process of determining the combination of endoscopes in the cleaning apparatus 1 according to the embodiment 1 of the present invention. Among two endoscopes set in the cleaning apparatus 1 for simultaneous cleaning, the determination unit 72 acquires the identification information of a first endoscope from the detection unit 80 (S10). The identification information of a second endoscope is then acquired (S11). Based on the identification information, the determination unit 72 identifies the combination of the set endoscopes (S12). Referring to the combination authorization information stored in the combination authorization information memory unit 79, the determination unit 72 then determines whether or not the combination of the endoscopes is allowed (S13). If the combination is not allowed (N in S13), the determination unit 72 notifies the notification unit 90 of the according information (S14), and then the determination process finishes. If the combination is allowed (Y in S13), the step S14 is skipped, and the determination process finishes.

According to the embodiment 1, as described above, acquiring the identification information of multiple endoscopes set in the cleaning apparatus 1 for simultaneous cleaning followed by determining in advance whether or not the combination thereof is allowed prevents an inappropriate combination of endoscopes from being cleaned simultaneously. Therefore, a failure of both the endoscopes and the cleaning apparatus and a situation where enough cleaning effects are not obtained, all caused by cleaning an inappropriate combination, can both be prevented.

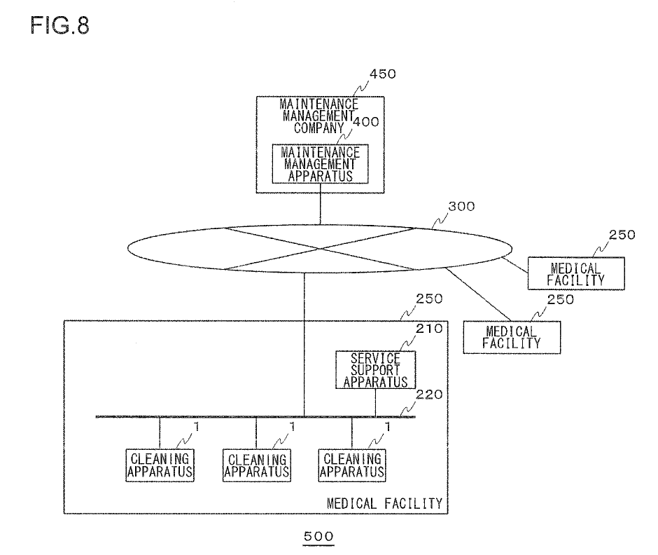

FIG. 8 is a view showing the whole configuration of a maintenance management system 500 according to the embodiment 2 of the present invention. The maintenance management system 500 is provided with a maintenance management apparatus 400 installed at a maintenance management company 450 and with the cleaning apparatus 1 and a service support apparatus 210 installed at a medical facility 250. In each of the medical facilities 250, the cleaning apparatus 1 and the service support apparatus 210 are connected to one another via an internal network 220 such as intranet. Each internal network 220 in each of the medical facilities 250 and the maintenance management apparatus 400 are connected to one another via an external network 300 such as Internet. The number of the medical facilities 250 and the number of the cleaning apparatuses 1 installed at each of the medical facilities 250 are intended to be illustrative only and are not intended to be limited to the numbers illustrated in FIG. 8.

The maintenance management company 450 has entered into a repair and maintenance contract for the cleaning apparatus 1 with each of the medical facilities 250. In the case of the failure of the cleaning apparatus 1 in the medical facility 250, the maintenance management company 450 sends a service engineer who repairs the cleaning apparatus 1. The service support apparatus 210 supports general services in the medical facility 250. In the embodiment, the cleaning history information of the cleaning apparatus 1 is stored.

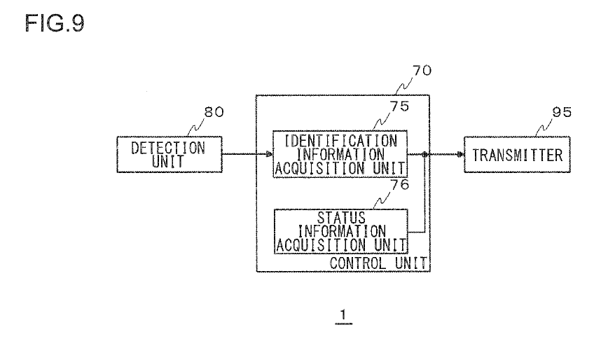

FIG. 9 is a functional block diagram of the cleaning apparatus 1 according to the embodiment 2 of the present invention. The cleaning apparatus 1 according to the embodiment is provided with the control unit 70, a detection unit 80, and a transmitter 95. The control unit 70 includes an identification information acquisition unit 75 and a status information acquisition unit 76. The rest of the configuration is the same as that of the cleaning apparatus 1 according to the embodiment 1.

The detection unit 80 detects both the identification information of an endoscope set in the cleaning apparatus 1 and the identification information of a person in charge of a cleaning task who sets the endoscope. Both the identification information of the endoscope and the identification information of the person in charge of the cleaning task, which are detected by the detection unit 80, are output to the identification information acquisition unit 75.

The identification information acquisition unit 75 acquires from the detection unit 80 both the identification information of the endoscope set in the cleaning apparatus 1 and the identification information of the person in charge of the cleaning task who put in the endoscopes, and identification information acquisition unit 75 passes the identification information to the transmitter 95. The status information acquisition unit 76 acquires various status information regarding the cleaning apparatus 1. For example, the cleaning starting time of an endoscope, the cleaning ending time of an endoscope, the generation of an error, the time required for supplying water, etc., are acquired from each unit in the cleaning apparatus 1 and then passed to the transmitter 95.

The transmitter 95 transmits the information passed from both the identification information acquisition unit 75 and the status information acquisition unit 76 to the service support apparatus 210 via the internal network 220. The transmitter 95 also transmits the information passed from both the identification information acquisition unit 75 and the status information acquisition unit 76 to the maintenance management apparatus 400 via the internal network 220 and the external network 300. The transmitter 95 may transmit the information passed from both the identification information acquisition unit 75 and the status information acquisition unit 76 in real time or on a regular basis, for example, once a minute or once a day. The extent and transmission timing of the information to be transmitted to the service support apparatus 210 and the maintenance management apparatus 400 may vary.

The cleaning history information generating unit 73 (see FIG. 5) and the cleaning history information memory unit 74 installed in the cleaning apparatus 1 according to the embodiment 1 may also be installed in the cleaning apparatus 1 according to the embodiment 2. In that case, the transmitter 95 can transmit the cleaning history information both generated by the cleaning history information generating unit 73 and stored in the cleaning history information memory unit 74 to the service support apparatus 210 and to the maintenance management apparatus 400.

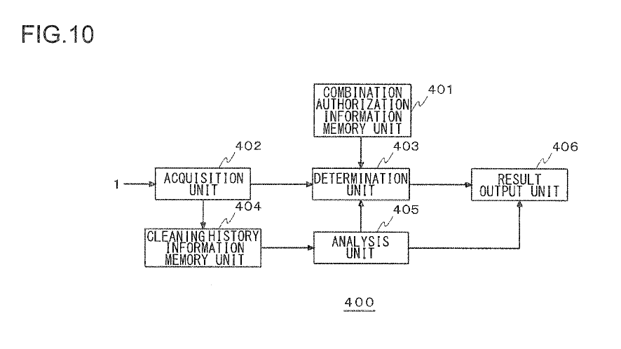

FIG. 10 is a functional block diagram of the maintenance management apparatus 400 according to the embodiment 2 of the present invention. The maintenance management apparatus 400 is provided with a combination authorization information memory unit 401, an acquisition unit 402, a determination unit 403, a cleaning history information memory unit 404, an analysis unit 405, and a result output unit 406.

For every combination of the various types of endoscopes, the combination authorization information memory unit 401 stores combination authorization information that specifies whether or not simultaneous cleaning performed in the cleaning apparatus 1 is allowed. If the types of the cleaning apparatuses 1 differ from one another, the combination authorization information needs to be generated for each type of the cleaning apparatuses 1.

The acquisition unit 402 acquires from the cleaning apparatus 1 via the internal network 220 and the external network 300 the identification information of multiple endoscopes set in the cleaning apparatus 1 for simultaneous cleaning. The identification information of the multiple set endoscopes may be acquired in a cleaning history information format from the cleaning apparatus 1 or from the service support apparatus 210.

Referring to the combination authorization information stored in the combination authorization information memory unit 401, the determination unit 403 determines whether or not the combination of the multiple endoscopes identified by the identification information of the multiple endoscopes acquired by the acquisition unit 402 falls into one of the combinations for which simultaneous cleaning is allowed. When it is found that the combination is not allowed for simultaneous cleaning as a result of the determination, the according information needs to be included in corresponding cleaning history information to be accumulated in the cleaning history information memory unit 404.

When the identification information can be acquired in real time from the cleaning apparatus 1 and when the notification unit 90 is provided in the cleaning apparatus 1, the cleaning apparatus 1 may be controlled remotely from the maintenance management apparatus 400 so as to notify the notification unit 90 accordingly when it is found as a result of the determination by the determination unit 403 that the combination is not allowed for simultaneous cleaning. When the identification information can be acquired in real time from the cleaning apparatus 1 and when it is found as a result of the determination by the determination unit 403 that the combination is not allowed for simultaneous cleaning, the cleaning apparatus 1 may be controlled remotely from the maintenance management apparatus 400 so that the cleaning of the multiple endoscopes set in the cleaning apparatus 1 are not cleaned.

The cleaning history information memory unit 404 stores the cleaning history information of the cleaning apparatus 1 that is accumulated as part of the information acquired by the acquisition unit 402 via the external network 300. The cleaning history information may be generated by the cleaning apparatus 1, by the service support apparatus 210, or by the maintenance management apparatus 400. When it is generated by the service support apparatus 210 or by the maintenance management apparatus 400, the cleaning history information generating unit (not shown) in the service support apparatus 210 or the maintenance management apparatus 400 acquires from the cleaning apparatus 1, for example, the identification information or the cleaning starting time of the endoscopes and generates the cleaning history information thereof.

The analysis unit 405 analyzes the cleaning history information stored in the cleaning history information memory unit 404. For example, the analysis unit 405 generates statistical data of the combinations of endoscopes for which simultaneous cleaning is not allowed, by using the cleaning history information of a past simultaneous cleaning stored in the cleaning history information memory unit 404. This allows for the generation of a ranking of the confusing combinations of endoscopes so as to call the attention of a person in charge of a cleaning task in each medical facility 250.

The analysis unit 405 generates statistical data of a person who sets the combination of endoscopes for which simultaneous cleaning is not allowed in the cleaning apparatus 1, by using the cleaning history information of a past simultaneous cleaning stored in the cleaning history information memory unit 404. This allows for the identification of the person in charge of a cleaning task who often sets an inappropriate combination of endoscopes, and the according information can be reported to each medical facility 250.

In accordance with instructions from a user, the result output unit 406 displays on a display unit (not shown) or prints out and then outputs determination results from the determination unit 403 and from the analysis unit 405. Based on this information, a service engineer from the maintenance management company 450 performs maintenance and management of the cleaning apparatus 1 in each medical facility 250.

In addition to a combination-determination function for endoscopes set for simultaneous cleaning, the maintenance management apparatus 400 according to the embodiment 2 has various functions for the maintenance and management of the cleaning apparatus 1 so as to support the services performed by a service engineer. Hereinafter, this system that supports the services performed by a service engineer is referred to as a remote diagnosis support system. An operator and a service engineer of the maintenance management company 450 can use this remote diagnosis support system.

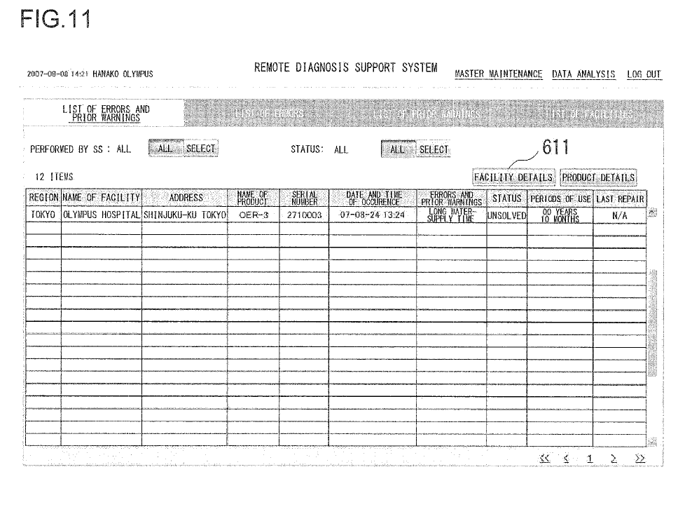

FIG. 11 shows the screen 610 of a remote diagnosis support system displaying the list of errors and prior warnings. A list of medical facilities where a cleaning apparatus having prior error or failure warnings was installed is displayed on the screen 610, displaying the list of errors and prior warnings. Only Olympus hospital is displayed in FIG. 11. By the user selecting a desired medical facility from the list of medical facilities and then pressing a facility detail button 611 on the screen 610 that displays the list of errors and prior warnings, the facility detail screen of the medical facility can be brought up.

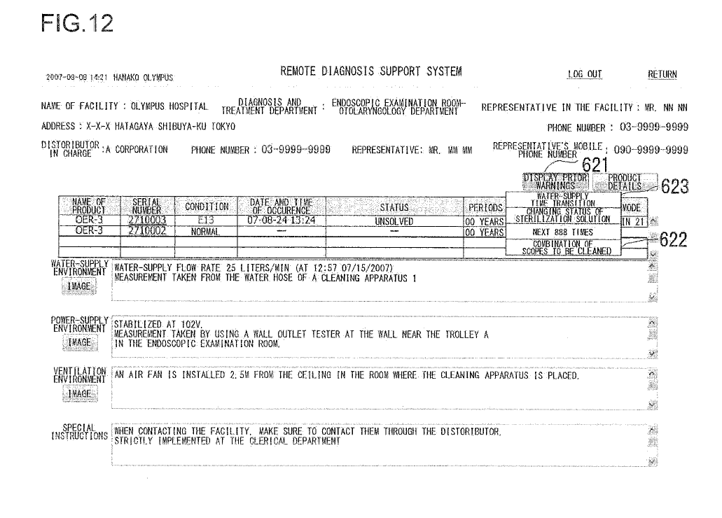

FIG. 12 shows a facility detail screen 620 of the remote diagnosis support system. A water-supply environment, a power-supply environment, a ventilation environment, and special instructions are displayed on this facility detail screen 620 for every cleaning apparatus 1 installed in the facility. There are comment fields for these items, and comments entered by a service engineer are displayed. On the facility detail screen 620, a selection menu is displayed when a user presses a prior warning display button 621. Selecting a combination-of-scopes-to-be-cleaned item 622 on the selection menu brings up a combination-of-scopes-to-be-cleaned error screen, and selecting a water-supply time transition item 623 brings up a water-supply time transition screen.

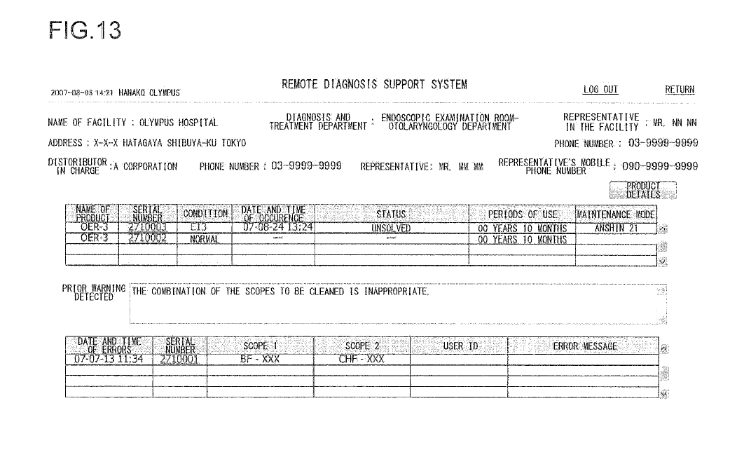

FIG. 13 shows a combination-of-scopes-to-be-cleaned error screen 630 of a remote diagnosis support system. On the combination-of-scopes-to-be-cleaned error screen 630, the date and time of an error, the serial number of a cleaning apparatus for which a combination error has occurred, and the model name of a scope for which a combination error has occurred are displayed.

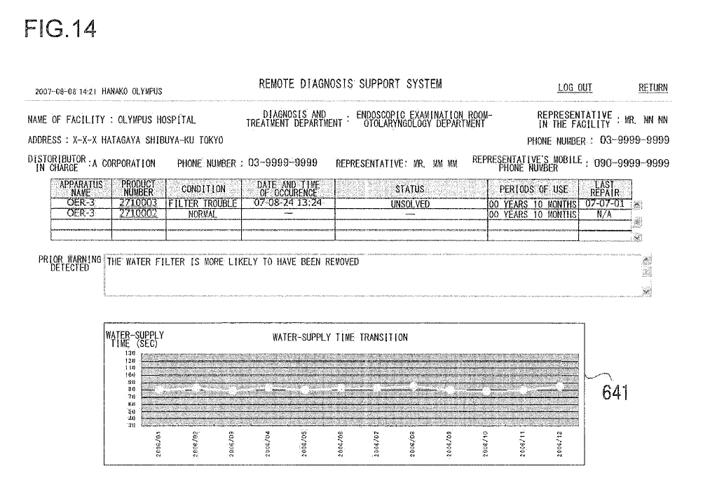

FIG. 14 shows a water-supply time transition screen 640 of a remote diagnosis support system. On the water-supply time transition screen 640, a graph 641 showing a water-supply time transition is displayed. Normally, if a water-supply filter is provided, clogging will gradually develop and the water-supply time will become longer. In the graph 641 shown in FIG. 14, since the water-supply time remains nearly constant, it is assumable that a water-supply filter is not provided. In other words, the acquisition unit 402 acquires the water-supply time information on a daily basis and registers the water-supply time information in a water-supply time history information memory unit (not shown), and the analysis unit 405 uses the history of the water-supply time information stored in the water-supply time history information memory unit so as to make the assumption.

According to the embodiment 2, as described above, since the information such as the combination of endoscopes set in the cleaning apparatus 1 for simultaneous cleaning can be acquired from each medical facility 250 via a network, the maintenance management company 450 can keep track of the status of use of the cleaning apparatus 1 in each medical facility 250 without sending a service engineer to the medical facility 250. Therefore, the burden of a service engineer performing services can be reduced. A failure of the cleaning apparatus 1 can be predicted based on objective data. In the case where the combination authorization information needs to be updated, only the combination authorization information in the combination authorization information memory unit 401 provided in the maintenance management apparatus 400 needs to be updated. This allows for simplifying the updating process.

Described above is an explanation based on the embodiments of the present invention. These embodiments are intended to be illustrative only and it will be obvious to those skilled in the art that various modifications to constituting elements and processes could be developed and that such modifications are also within the scope of the present invention.

In the above-stated embodiment, a cleaning apparatus 1 that can clean two endoscopes simultaneously is shown. However, the present invention can also be applied to a cleaning apparatus that can clean three or more endoscopes simultaneously.

What is claimed is:

1. A cleaning apparatus that can clean a plurality of endoscopes simultaneously comprising:
a combination authorization information memory unit operative to store combination authorization information that specifies whether or not simultaneous cleaning in the cleaning apparatus is allowed for every combination of various types of endoscopes; and
a determination unit operative, referring to the combination authorization information stored in the combination authorization information memory unit, to determine whether or not the combination of endoscopes set to be cleaned simultaneously in the cleaning apparatus falls into one of the allowed combinations.

2. The cleaning apparatus according to claim 1 further comprising:
a detection unit operative to detect the identification information of an endoscope set in the cleaning apparatus, wherein
the determination unit acquires, prior to the simultaneous cleaning, the respective identification information of the plurality of endoscopes detected by the detection unit, then identifies the type of each endoscope from the identification information, and identifies the combination of the endoscopes.

3. The cleaning apparatus according to claim 2 further comprising: a notification unit operative, when the determination unit determines that a combination of endoscopes that is not allowed for simultaneous cleaning is set in the cleaning apparatus, to notify a worker of the according information.

4. The cleaning apparatus according to claim 2 further comprising: a notification unit operative, when the determination unit determines that a combination of endoscopes that is not allowed for simultaneous cleaning is set in the cleaning apparatus, to notify a worker of the according information.

5. A maintenance management apparatus connected via a network to a cleaning apparatus that can clean a plurality of endoscopes simultaneously comprising:
a combination authorization information memory unit operative to store combination authorization information that specifies whether or not simultaneous cleaning in the cleaning apparatus is allowed for every combination of various types of endoscopes;
an acquisition unit operative to acquire from the cleaning apparatus via the network the identification information of a plurality of endoscopes set in the cleaning apparatus to be cleaned simultaneously in the cleaning apparatus; and
a determination unit operative, referring to the combination authorization information stored in the combination authorization information memory unit, to determine whether or not the combination of a plurality of endoscopes identified by the identification information of a plurality of endoscopes acquired by the acquisition unit falls into one of the allowed combinations.

6. The maintenance management apparatus according to claim 5 further comprising:
a cleaning history information memory unit operative to store the cleaning history information of the cleaning apparatus that is accumulated based on the information acquired by the acquisition unit via the network; and
an analysis unit operative to analyze the cleaning history information stored in the cleaning history information memory unit.

7. The maintenance management apparatus according to claim 6 wherein the analysis unit generates statistical data of the combination of endoscopes for which simultaneous cleaning is not allowed, by using the cleaning history information of a past simultaneous cleaning stored in the cleaning history information memory unit.

8. The maintenance management apparatus according to claim 6 wherein the analysis unit generates statistical data of a worker who sets the combination of endoscopes in the cleaning apparatus for which simultaneous cleaning is not allowed, by using the cleaning history information of a past simultaneous cleaning stored in the cleaning history information memory unit.
